(19) United States
(12) Patent Application Publication
(10) Pub. No.: US 2011/0284809 A1
(43) Pub. Date: Nov. 24, 2011

(54) PARTICLES, METHOD OF PRODUCING PARTICLES, AND COATING MATERIAL, FILM, AND INK INCLUDING PARTICLES

(75) Inventors: Ping Jin, Aichi (JP); Shidong Ji, Aichi (JP)

(73) Assignee: National Institute of Advanced Industrial Science and Technology, Tokyo (JP)

(21) Appl. No.: 13/146,429

(22) PCT Filed: Jan. 29, 2010
(86) PCT No.: PCT/JP2010/051665

§ 371 Date: Jul. 27, 2011

(30) Foreign Application Priority Data
Feb. 9, 2009 (JP) 2009027727

(51) Int. Cl. B32B 5/00; G02F 1/00; C01G 31/02

(52) U.S. Cl. 252/583; 423/594.17; 428/402

(57) ABSTRACT

Particles having a thermochromic property include rod-shaped single crystals including vanadium dioxide (VO₂). The aspect ratio of the long axis to the short axis of the rod-shaped single crystals is greater than 3 and less than or equal to 100, and the average length of the short axes of the rod-shaped single crystals is less than or equal to 500 nm.

### TECHNICAL FIELD

The present invention generally relates to particles. More particularly, the present invention relates to particles including vanadium dioxide (VO₂) of a rutile crystal phase. The present invention also relates to a method of producing the particles and a coating material, a film, and ink including the particles.

### BACKGROUND ART

Generally, a large amount of heat exchange occurs at an interface between the inside of, for example, a house, a building, or a mobile body such as a vehicle and the external environment. Thermochromic materials are promising materials for partitions (e.g., windowpanes) that can be used at such an interface to achieve both energy saving and comfort.

Here, “thermochromic materials” indicate materials whose optical properties such as transparency and reflectivity can be controlled by temperature. For example, windowpanes including a thermochromic material may be configured to reflect sunlight during summer to shut out the heat and to transmit sunlight during winter to utilize the heat.

A thermochromic material including vanadium dioxide (VO₂) is one of the most promising thermochromic materials. This thermochromic material exhibits a thermochromic property (a behavior where the optical property reversibly changes according to the temperature) when the phase transition of vanadium dioxide (VO₂) occurs at around the ambient temperature. In other words, the thermochromic material has an ambient-temperature-dependent thermochromic property.

For example, glass having such a thermochromic property may be produced by coating a glass substrate with vanadium dioxide (VO₂) by sputtering. As another example, glass having a thermochromic property may be produced by forming a thin film of vanadium dioxide (VO₂) on a substrate by sputtering, transferring the thin film onto a support film, and then transferring the thin film from the support film onto a glass substrate (see, for example, patent documents 1 through 3). However, with the related-art methods where a sputtering process is used, it is necessary to heat a substrate up to, for example, about 350° C. to 650° C. to form a vanadium dioxide (VO₂) film with good crystallinity. This in turn complicates the production process and increases the production cost. Also, it is difficult to coat, for example, existing windowpanes of a building by sputtering.

For the above reasons, another method of producing a material (or a component) having a thermochromic property has been proposed (see, for example, patent documents 4 through 6 and non-patent documents 2 through 4). In the proposed method, particles including vanadium dioxide (VO₂) or a dispersion liquid including the particles is prepared and fixed to a material using, for example, an adhesive.

### RELATED-ART DOCUMENTS

### Patent Documents

Patent document 1: Japanese Patent No. 3849008
Patent document 2: Japanese Laid-Open Patent Publication No. 2006-256902
Patent document 3: Japanese Laid-Open Patent Publication No. 2007-326276
Patent document 4: Japanese Laid-Open Patent Publication No. 10-508573
Patent document 5: Japanese Laid-Open Patent Publication No. 2004-346260
Patent document 6: Japanese Laid-Open Patent Publication No. 2004-346261

### Non-Patent Documents

Non-patent document 1: “Latest technologies in functional glass/nano-glass”, NTS inc., Chapter 5 Section 3, pages 304-322 (2006)
Non-patent document 2: Jianqiu Shi, Shuxue Zhou, Bo You, Limin Wu; Solar Energy Materials and Solar Cells 91 (2007) 1856
Non-patent document 3: Hisao Suzuki, Kenji Yamaguchi, Hidetoshi Miyazaki; Composite Science and Technology 67 (2007) 3487
Non-patent document 4: F. Guinneton, L. Sauques, J. C. Valmalette, F. Cros, J. R. Gavarri; Journal of Physics and Chemistry of Solids 62 (2001) 1229
Non-patent document 5: Kinson C. Kam, Anthony K. Cheetham; Materials Research Bulletin 41(2006) 1015
Non-patent document 6: Kai-Feng Zhang, Xiang Liu, Zhong-Xing Su, Hu-Lin Li; Materials Letters 61 (2007) 2644

### DISCLOSURE OF INVENTION

### Problems to be Solved by the Invention

Vanadium dioxide (VO₂) has multiple polymorphic crystal phases such as A phase, B phase, C phase, and rutile crystal phase (R phase). However, only vanadium dioxide (VO₂) of the rutile crystal phase (hereafter called the R phase) exhibits a thermochromic property as described above. Also, to make vanadium dioxide (VO₂) particles exhibit a significant or substantial thermochromic property, the vanadium dioxide (VO₂) particles of the R phase need to be of a submicron size or a smaller size.

In the technologies disclosed in patent documents 4 through 6, a precursor of vanadium dioxide (VO₂) is synthesized from a solution including vanadium, and vanadium dioxide (VO₂) particles of the R phase are prepared by performing reduction firing or thermal decomposition on the powder of the precursor at a high temperature of from about 300° C. to about 650° C.

However, heat treatment at such a high temperature causes a solid phase reaction and thereby causes the particles to grow or agglomerate together. Therefore, with the related-art method, the resulting vanadium dioxide (VO₂) particles tend to vary in size and have a micron size. As a result, the vanadium dioxide (VO₂) particles obtained with the related-art method may not exhibit a thermochromic property or may exhibit only a poor thermochromic property.

Recently, several reports have been made on a method of producing vanadium dioxide (VO₂) particles using a hydrothermal reaction (see, for example, non-patent documents 5 and 6). However, the vanadium dioxide (VO₂) particles produced by the reported method are made of, for example, B-phase crystals that do not exhibit the thermochromic property. Therefore, to make the produced vanadium dioxide (VO₂) particles exhibit a good thermochromic property, it is necessary to transform the vanadium dioxide (VO₂) particles into the R phase by, for example, performing controlled heat treatment in an atmospheric gas (e.g., N₂ or Ar) at a high temperature (e.g., from 500° C. to 700° C.).

However, as described above, heat treatment at such a high temperature causes a solid phase reaction and thereby causes the particles to grow or agglomerate together. Therefore, even with the reported method, it is difficult to obtain uniform vanadium dioxide (VO₂) particles with a submicron size, and vanadium dioxide (VO₂) particles obtained by the reported method may exhibit a poor thermochromic property.

One object of the present invention is to solve or reduce one or more problems caused by the limitations and disadvantages of the related art and to provide particles with a good thermochromic property, a method of producing the particles, and a coating material, a film, and ink including the particles.

### Means for Solving the Problems

An aspect of the present invention provides particles having a thermochromic property. The particles include rod-shaped single crystals including vanadium dioxide (VO₂). The aspect ratio of the long axis to the short axis of the rod-shaped single crystals is greater than 3 and less than or equal to 100, and the average length of the short axes of the rod-shaped single crystals is less than or equal to 500 nm.

The rod-shaped single crystals may further include at least one element selected from the group consisting of tungsten (W), molybdenum (Mo), niobium (Nb), tantalum (Ta), and fluorine (F).

The rod-shaped single crystals may be two-dimensionally or three-dimensionally combined to form aggregates.

Another aspect of the present invention provides thermochromic fines obtained by grinding the particles.

Another aspect of the present invention provides a method of producing particles having a thermochromic property. The method includes a step of performing a hydrothermal reaction process at a temperature of 250 degrees or higher on a solution that includes a substance A including vanadium (V), a substance B having oxidizing or reducing ability, and water, and thereby forming particles including rod-shaped single crystals that include vanadium dioxide. The aspect ratio of the long axis to the short axis of the rod-shaped single crystals is greater than 3 and less than or equal to 100, and the average length of the short axes of the rod-shaped single crystals is less than or equal to 500 nm.

The substance A including vanadium (V) may include at least one member selected from the group consisting of divanadium pentoxide (V₂O₅), vanadyl oxalate (VOC₂O₄), and vanadyl oxalate hydrate (VOC₂O₄-nH₂O).

The substance B having oxidizing or reducing ability may include at least one member selected from the group consisting of oxalic acid ((COOH)₂), oxalic acid hydrate ((COOH)₂-nH₂O), and hydrogen peroxide (H₂O₂).

The method may further include a step of adding an acidic or basic substance C to the solution.

The acidic or basic substance C may include at least one member selected from the group consisting of hydrochloric acid, nitric acid, phosphoric acid, sulfuric acid, and ammonium hydroxide.

The hydrothermal reaction process may be performed for a period of time that is less than five days.

The method may further include a step of adding a substance including at least one element selected from the group consisting of tungsten (W), molybdenum (Mo), niobium (Nb), tantalum (Ta), and fluorine (F) to the solution.

Still another aspect of the present invention provides a coating material, a film, and ink including the above described particles.

### Advantageous Effect of the Invention

An aspect of the present invention makes it possible to provide particles with a good thermochromic property, a method of producing the particles, and a coating material, a film, and ink including the particles.

### BRIEF DESCRIPTION OF THE DRAWINGS

FIG. 1 is a graph showing an XRD pattern of particles of example 1;

FIG. 2 is a SEM photograph of the particles of example 1;

FIG. 3 is a SEM photograph of a surface of a film to which the particles of example 1 are applied;

FIG. 4 is a graph showing a thermochromic property of a glass substrate sample including the particles of example 1;

FIG. 5 is a graph showing an XRD pattern of particles of example 2;

FIG. 6 is a SEM photograph of the particles of example 2;

FIG. 7 is a SEM photograph of fines obtained by grinding the particles of example 2;

FIG. 8 is a graph showing an XRD pattern of particles of example 3;

FIG. 9 is a SEM photograph of the particles of example 3;

FIG. 10 is a SEM photograph of a surface of a film to which the particles of example 3 are applied;

FIG. 11 is a graph showing an XRD pattern of vanadium dioxide powder of comparative example 1;

FIG. 12 is a SEM photograph of the vanadium dioxide powder of comparative example 1;

FIG. 13 is a SEM photograph of a surface of a film to which the vanadium dioxide powder of comparative example 1 is applied;

FIG. 14 is a graph showing a thermochromic property of a glass substrate sample including the vanadium dioxide powder of comparative example 1;

FIG. 15 is a graph showing an XRD pattern of particles of comparative example 2;

FIG. 16 is a SEM photograph of the particles of comparative example 2;

FIG. 17 is a SEM photograph of particles of example 4;

FIG. 18 is a SEM photograph of particles of example 5;

FIG. 19 is a graph showing a thermochromic property of a glass sample to which a coating material of example 6 is applied;

FIG. 20 is a graph showing a thermochromic property of a film sample of example 7; and

FIG. 21 is a graph showing a thermochromic property of an ink sample of example 8.

### BEST MODE FOR CARRYING OUT THE INVENTION

Preferred embodiments of the present invention are described below.

An embodiment of the present invention provides particles having a thermochromic property. The particles include rod-shaped single crystals including vanadium dioxide (VO₂), an aspect ratio of the long axis to the short axis of the rod-shaped single crystals is greater than 3 and less than or equal to 100, and an average length of the short axes of the rod-shaped single crystals is less than or equal to 500 nm.

As described above, in a related-art method, vanadium dioxide (VO₂) particles of the rutile crystal phase (R phase) are obtained by synthesizing a precursor of vanadium dioxide (VO₂) from a solution including vanadium and by heat-treating the precursor at a high temperature (e.g., from about 300° C. to about 650° C.). In another related-art method, vanadium dioxide (VO₂) particles of the R phase are obtained by preparing vanadium dioxide (VO₂) particles of, for example, the B phase using a hydrothermal reaction and by heat-treating the prepared vanadium dioxide (VO₂) particles at a high temperature (e.g., from about 500° C. to about 700° C.). Here, “hydrothermal reaction” indicates a chemical reaction that occurs in hot water (subcritical water) whose temperature and pressure are lower than the critical point (374° C., 22 MPa) of water.

Both of the related-art methods require an additional heat treatment process at a high temperature and therefore complicate the production process. Also, heat treatment at such a high temperature causes a solid phase reaction and thereby causes the particles to grow or agglomerate together. Therefore, with the related-art methods, it is difficult to obtain vanadium dioxide (VO₂) particles of the R phase with a uniform submicron size. Also, agglomerated particles obtained as a result of the solid phase reaction tend to have defects, lack in uniformity, and have poor crystallinity. Thus, with the related-art methods, it is difficult to obtain particles with a sufficiently good thermochromic property.

For example, with a film including particles disclosed in non-patent document 3, the difference in transmittance in the infrared region (2500-nm wavelength) before and after the phase transition is merely about 12%. The technology disclosed in non-patent document 3 is substantially the same as the technology disclosed in patent document 6. Also, with a film including particles disclosed in non-patent document 2, the difference in transmittance in the infrared region (2500-nm wavelength) before and after the phase transition is merely about 20 several %.

Meanwhile, an embodiment of the present invention makes it possible to obtain vanadium dioxide (VO₂) particles of the R phase in the form of separate single-crystal particles directly from a solution through one step, and therefore makes it possible to obtain uniform vanadium dioxide (VO₂) particles of the R phase that have less defects and good crystallinity.

In general, to reduce defects of particles and to improve the crystallinity of crystals constituting the particles, it is preferable to grow the crystals to have a large size. However, as the size of vanadium dioxide (VO₂) crystals increases (for example, to a micron size), the thermochromic property of the crystals is degraded and the light transmittance of the crystals decreases greatly.

In this embodiment, vanadium dioxide (VO₂) single-crystals may have a rod-like shape, and the aspect ratio of the long axis to the short axis of the vanadium dioxide (VO₂) single crystals may be greater than 3 and less than or equal to 100. Also in this embodiment, the average length of the short axes of the vanadium dioxide (VO₂) single-crystals is less than or equal to 500 nm.

Since the long axis of each rod-shaped single crystal is sufficiently long, the vanadium dioxide (VO₂) single crystals of this embodiment have good crystallinity. Also, since each rod-shaped single crystal has a nano-size short axis, degradation of the thermochromic property and decrease in the light transmittance can be prevented (when the short axis is parallel to the direction of incidence of light).

With the above configuration, particles of this embodiment have a better thermochromic property than related-art particles.

Although the length of the short axis of each rod-shaped single crystal of this embodiment is less than or equal to 500 nm, the length of the short axis may be less than or equal to 200 nm or less than or equal to 100 nm.

The rod-shaped single crystals may be two-dimensionally combined to form, for example, V- or X-shaped particles (or agglomerates). Alternatively, the rod-shaped single crystals may be three-dimensionally combined to form, for example, star(*)-shaped particles (or agglomerates).

In this embodiment, the rod-shaped single crystals may include, in addition to vanadium dioxide (VO₂), at least one element selected from the group consisting of tungsten (W), molybdenum (Mo), niobium (Nb), tantalum (Ta), and fluorine (F). Adding such an element to the rod-shaped single crystals makes it possible to control the phase transition characteristics (particularly, thermochromic temperature) of particles. The total amount of additives to the particles is preferably from about 0.1 to about 5.0 atomic percent and more preferably about 1.0 atomic percent with respect to vanadium (V) atoms. Adding more than 5.0 atomic percent of substances (or elements) may degrade the thermochromic property (e.g., the difference in transmittance before and after the phase transition) of the particles.

At least a part of the surface of each of the particles of this embodiment may be coated or modified. This makes it possible to protect the surfaces of the particles, to improve the surface property of the particles, and/or to control the optical property of the particles.

An embodiment of the present invention also provides a dispersion liquid including particles having a thermochromic property. The dispersion liquid may be prepared by dispersing the particles of the above embodiment in an organic solvent such as alcohol or an inorganic solvent such as water.

Also, the particles of this embodiment may be ground to obtain finer particles with a nanometer size. Since the crystals constituting the particles of this embodiment have a high aspect ratio, the particles can be easily crushed in a direction that intersects with the length direction of the particles.

### <Production Method of Particles>

An exemplary method of producing particles of this embodiment is described below. However, the particles of this embodiment may be produced by any other appropriate method.

(1) First, a substance A including vanadium (V) and a substance B having oxidizing or reducing ability are prepared. Exemplary compounds that can be used as the substance A include divanadium pentoxide (V₂O₅), vanadyl oxalate (VOC₂O₄), vanadyl oxalate hydrate (VOC₂O₄-nH₂O), vanadium oxide sulfate (VOSO₄), and vanadium oxide sulfate hydrate (VOSO₄-nH₂O). Exemplary compounds that can be used as the substance B include oxalic acid ((COOH)₂), oxalic acid hydrate ((COOH)₂-nH₂O), and hydrogen peroxide (H₂O₂).

(2) Next, at least one of the compounds for the substance A and at least one of the compounds for the substance B are added to water. As a result, an aqueous solution (when both of the substances A and B dissolve in the water) or a suspension (when at least one of the substances A and B does not dissolve in the water) is obtained (hereafter, regardless of whether the aqueous solution or the suspension is obtained, the obtained liquid is called a solution). An acidic or basic substance C may also be added to the solution as necessary. The substance C may include at least one of hydrochloric acid, nitric acid, phosphoric acid, sulfuric acid, and ammonium hydroxide. The substance C is added to control the pH value of the solution. The pH value of the solution is preferably between 0.5 and 7.0 and more preferably about 0.7.

Further, at least one element selected from a substance group D below or a compound of the selected element may be added to the solution.

Substance group D: tungsten (W), molybdenum (Mo), niobium (Nb), tantalum (Ta), stannum (Sn), rhenium (Re), iridium (Ir), osmium (Os), ruthenium (Ru), germanium (Ge), chromium (Cr), iron (Fe), gallium (Ga), aluminum (Al), fluorine (F), and phosphorus (P).

Adding such an element or compound makes it possible to control the phase transition characteristics (particularly, thermochromic temperature) of particles.

(3) Next, a hydrothermal reaction process is performed on the solution. The hydrothermal reaction process may be performed, for example, in an autoclave. As a result of the hydrothermal reaction process, particles including rod-shaped single-crystals including vanadium dioxide are obtained.

The hydrothermal reaction process may be performed, for example, at a temperature of 250° C. or higher (e.g., 270° C.). The period of time for the hydrothermal reaction process varies depending on various conditions such as the amount of reactants, the processing temperature, and the processing pressure. For example, the period of time for the hydrothermal reaction process may be less than seven days, from one hour to five days, or about twelve hours. Increasing the processing time makes it easier to control, for example, the size of particles obtained. However, increasing the processing time increases energy consumption.

The hydrothermal reaction process is not necessarily a batch process, but may be a continuous process.

(4) As necessary, the surfaces of the particles may be coated or modified. This step makes it possible to protect the surfaces of the particles, to improve the surface property of the particles, and/or to control the optical property (thermochromic property) of the particles. For the coating process or the surface modification process, a silane coupling agent may be used.

Through the above steps, a suspension where rod-shaped vanadium-dioxide (VO₂) single-crystals are precipitated is obtained. Then, the precipitates are recovered from the suspension by filtration, washing, and/or drying to obtain the particles.

The method of this embodiment includes no such heat treatment like that used in the related-art methods, and therefore makes it possible to simplify the production process. Also, the obtained particles do not agglomerate together due to such heat treatment. Thus, the method of this embodiment makes it possible to obtain uniform and fine particles with a good thermochromic property.

### <Usage of Particles>

The particles of this embodiment may be used, for example, for a coating material having a thermochromic property, a film having a thermochromic property, and ink having a thermochromic property. For example, a coating material and ink having a thermochromic property may be prepared by adding the particles of this embodiment to a common (e.g., commercially available) coating material. Similarly, a film having a thermochromic property may be prepared by adding the particles of this embodiment as a filler to a common (e.g., commercially available) material of a transparent film such as a resin film.

### EXAMPLES

Embodiments of the present invention are described below in more detail by means of examples. However, the present invention is not limited to those examples.

### Example 1

Vanadium pentoxide (V₂O₅, Wako Special Grade), oxalic acid dihydrate ((COOH)₂-2H₂O, Wako Special Grade), and 200 ml of pure water were mixed and agitated at a molar ratio of 1:2:300 at the ambient temperature to prepare an aqueous solution. The pH value of the aqueous solution was adjusted to 0.7 using sulfuric acid.

Next, 10 ml of the aqueous solution was placed in a commercially-available hydrothermal reaction autoclave (HU-25 of Sanai Kagaku Corporation, HU-25 includes a body made of SUS and an inner cylinder made of Teflon (registered trademark) and having a volume of 25 ml), and a hydrothermal reaction process was performed for 12 hours at 270° C.

Next, precipitated products in the resulting aqueous solution were extracted by filtration and washed using water and ethanol. The precipitated products were dried at 60° C. for 10 hours. As a result, particles were obtained (as described below, it was confirmed that the particles include vanadium dioxide (VO₂) of the R phase).

Next, a five-percent aqueous solution of silane coupling agent (KBM-603 of Shin-Etsu Chemical Co., Ltd.) was prepared, and the obtained particles were put in the aqueous solution to modify the surfaces of the particles. Then, the particles were recovered from the aqueous solution and dried at 110° C. for one hour.

### <Evaluation>

The characteristics of the particles of example 1 were evaluated.

The particles were applied uniformly to a surface of a highly-transparent resin adhesive tape and the adhesive tape was affixed to a transparent resin film to obtain a film sample for evaluation. Also, an adhesive tape prepared in the same manner was affixed to a glass substrate to obtain a glass substrate sample (length 25 mm×width 25 mm×thickness 1 mm) for evaluation.

The microstructure of the particles themselves was observed with an FE-SEM apparatus (Hitachi S-4300 of Hitachi, Ltd.). The film sample was observed with the FE-SEM apparatus to evaluate the orientation of the particles.

The crystallinity of the particles themselves was evaluated with a powder X-ray diffractometer (X′Pert-MPD of Philips).

The thermochromic property of the particles was measured with a heatable spectrophotometer (V-570 of JASCO Corporation, 190-2500 nm) using the glass substrate sample. The measurement was performed at 20° C. and 80° C.

Also, whether the crystals constituting the particles were single crystals was determined based on electron diffraction patterns obtained by TEM observation.

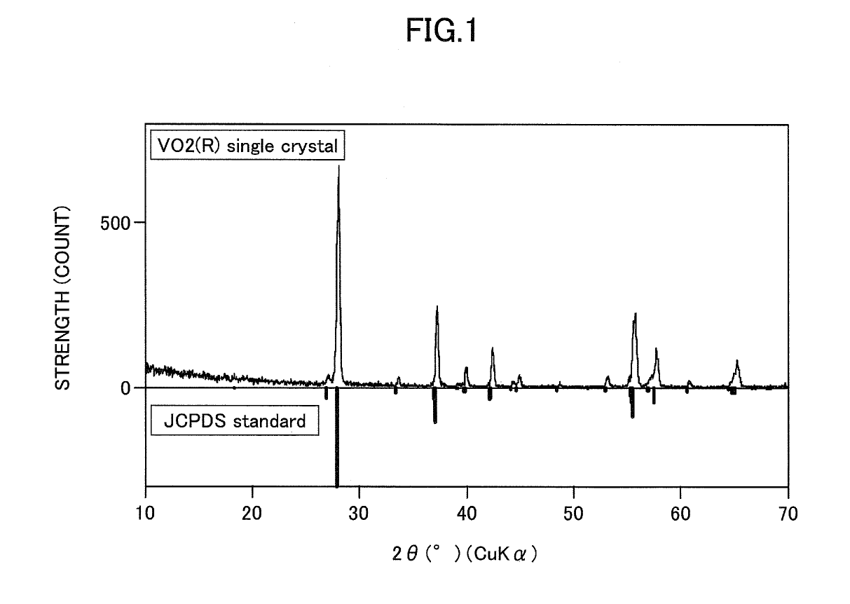

FIG. 1 is a graph showing powder X-ray diffraction (XRD) measurements of the particles of example 1 together with a standard diffraction pattern of vanadium dioxide (VO₂) crystals of the R phase (JCPDS82-0661) (the lower part of FIG. 1). As shown in FIG. 1, all diffraction peaks of the particles of example 1 match the standard peaks of vanadium dioxide (VO₂) crystals of the R phase having the thermochromic property. Also as shown in FIG. 1, the diffraction peaks are sharp and their half widths are narrow. This indicates that although the particles are fine crystals, they have very good crystallinity.

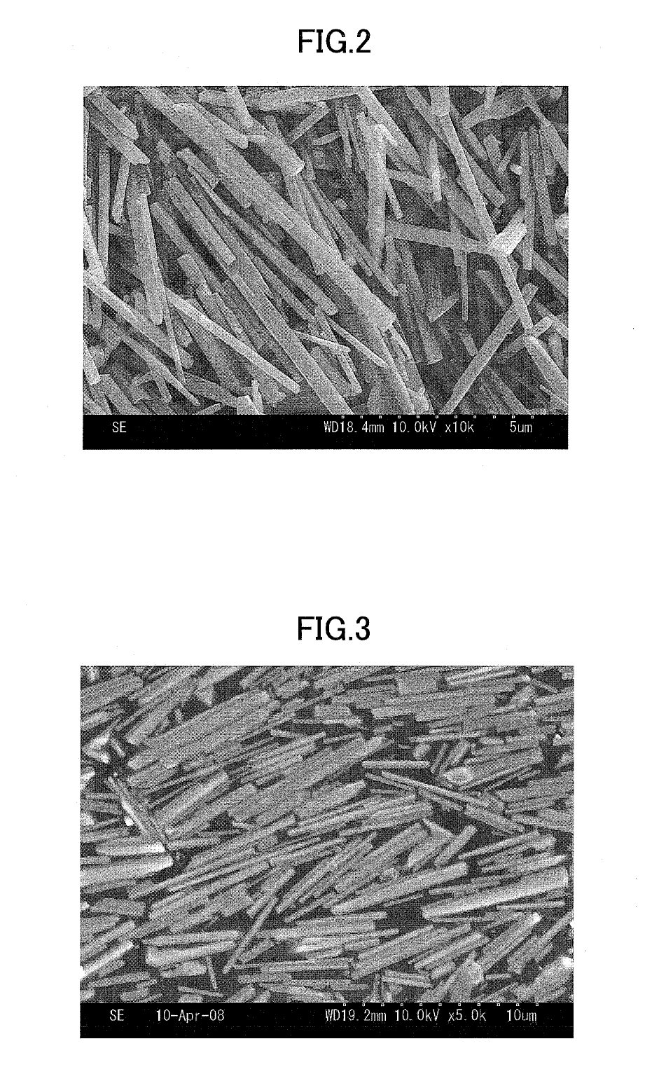

FIG. 2 is a SEM photograph of the particles of example 1. As in FIG. 2, the particles are composed of rod-shaped crystals. The average length of the short axes of the rod-shaped crystals was less than or equal to about 500 nm, and the lengths of the long axes of the rod-shaped crystals were ten or more times greater than the average length of the short axes (i.e., aspect ratio>10). Also, the rod-shaped crystals had a substantially uniform size. In other words, the particles were highly uniform. Further, TEM observation of the particles showed that the rod-shaped crystals were single crystals.

FIG. 3 is a SEM photograph of a surface of the film sample. As in FIG. 3, rod-shaped crystals of a substantially uniform size and shape were arranged on the surface of the film sample with their long axes oriented parallel to the surface of the film sample.

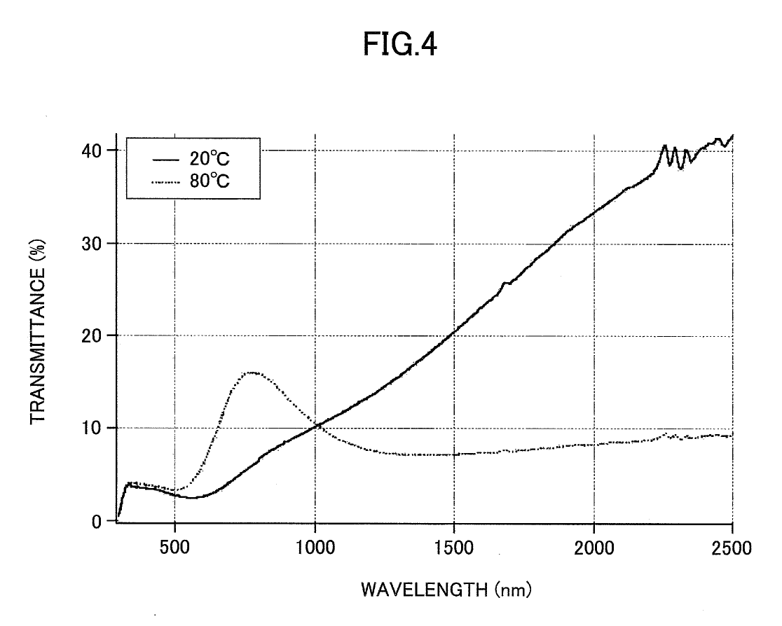

FIG. 4 is a graph showing the thermochromic property of the particles measured using the glass substrate sample. When the temperature was increased from 20° C. to 80° C., the transmittance of the particles greatly changed due to the phase transition of vanadium dioxide (VO₂) from semiconductor to metal. For example, at a wavelength of 2500 nm, the optical transmittance of the particles changed about 30% when the temperature was increased from 20° C. to 80° C. As described above, at the same wavelength, the optical transmittance of particles produced by a related-art method (non-patent document 3) changes only about 12% and the optical transmittance of particles produced by another related-art method (non-patent document 2) changes only about 20%. Thus, the particles of example 1 have a very good thermochromic property.

According to the transmittance change curve of the particles at a wavelength of 2000 nm, the transition temperature of the particles was about 69° C.

### Example 2

Vanadium pentoxide (V₂O₅, Wako Special Grade), oxalic acid dihydrate ((COOH)₂-2H₂O, Wake Special Grade), and 200 ml of pure water were mixed and agitated at a molar ratio of 1:2:300 at the ambient temperature to prepare an aqueous solution.

Next, 10 ml of the aqueous solution was placed in a commercially-available hydrothermal reaction autoclave (HU-25 of Sanai Kagaku Corporation, HU-25 includes a body made of SUS and an inner cylinder made of Teflon (registered trademark) and having a volume of ml), and a hydrothermal reaction process was performed for 24 hours at 270° C.

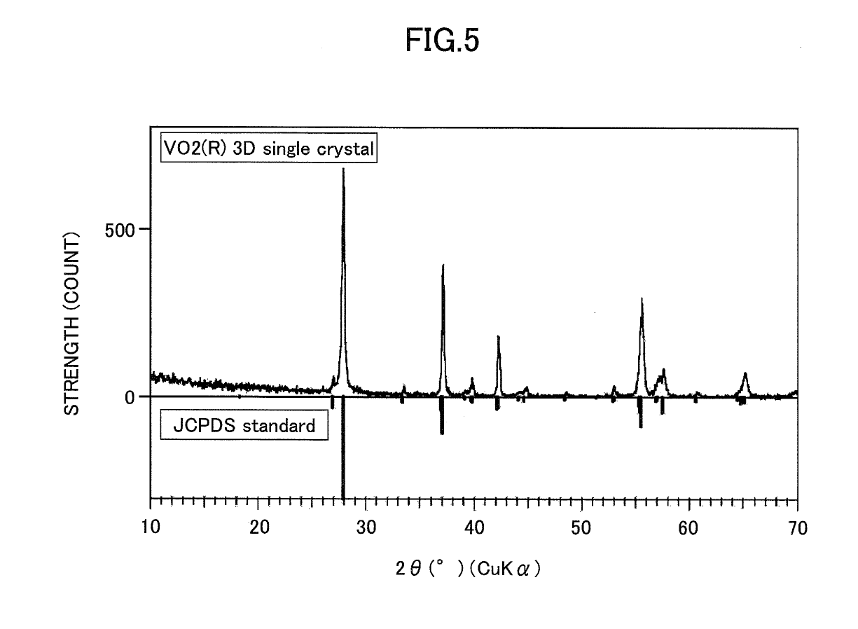

FIG. 5 is a graph showing powder X-ray diffraction (XRD) measurements of the particles of example 2 together with a standard diffraction pattern of vanadium dioxide (VO₂) crystals in the R phase (JCPDS82-0661) (the lower part of FIG. 5). As shown in FIG. 5, all diffraction peaks of the particles of example 2 also match the standard peaks of vanadium dioxide (VO₂) crystals of the R phase having the thermochromic property. Also as shown in FIG. 5, the diffraction peaks are sharp and their half widths are narrow. This indicates that although the particles are fine crystals, they have very good crystallinity.

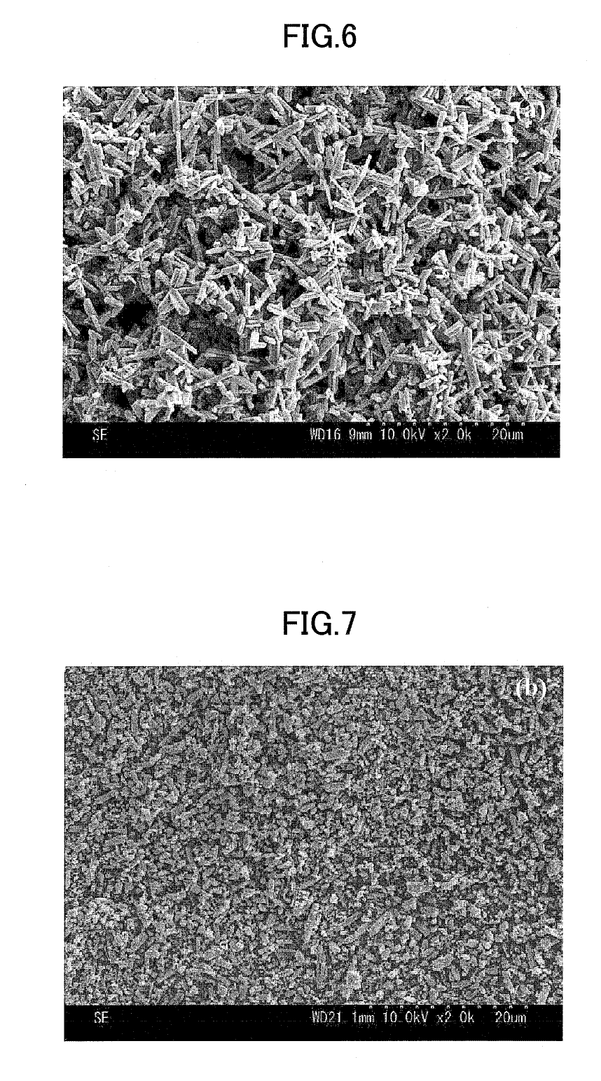

FIG. 6 is a SEM photograph of the particles of example 2. As in FIG. 6, each of the particles of example 2 has a structure where multiple rod-shaped crystals as shown in FIG. 2 are combined two-dimensionally (to form, for example, a V-shape and an X-shape) or three-dimensionally (to form, for example, a star(*)-shape). Further, TEM observation of the particles showed that the rod-shaped crystals were single crystals.

FIG. 7 is a SEM photograph of fines obtained by grinding the particles of example 2 in an agate mortar. As in FIG. 7, the particles were ground to break the rod-shaped crystals in a direction that intersects with the length direction of the rod-shaped crystals to obtain thermochromic fines.

### Example 3

A suspended solution was prepared by adding 0.83 g of vanadyl oxalate hydrate (VOC₂O₄-nH₂O, Wako Pure Chemical Industries, Ltd.), 0.36 g of hydrogen peroxide (Wako Pure Chemical Industries, Ltd.), 0.015 g of ammonium tungstate para pentahydrate ((NH₄) 10W₁₂O₄₁-5H₂O, Wako Pure Chemical Industries, Ltd.), and 1.75 g of sulfuric acid solution (1M, Wako Pure Chemical Industries, Ltd.) to 10 ml of pure water. The suspended solution was placed in a commercially-available hydrothermal reaction autoclave (HU-25 of Sanai Kagaku Corporation, HU-25 includes a body made of SUS and an inner cylinder made of Teflon (registered trademark) and having a volume of 25 ml) for a hydrothermal reaction process. The hydrothermal reaction process was performed at 100° C., for 10 hours and at 270° C. for 12 hours.

In example 3, ammonium tungstate para pentahydrate ((NH₄) 10W₁₂O₄₁-5H₂O) was added to lower the transition temperature of particles to be obtained. The proportion of tungsten (W) atoms to vanadium (V) atoms is about 1.5%.

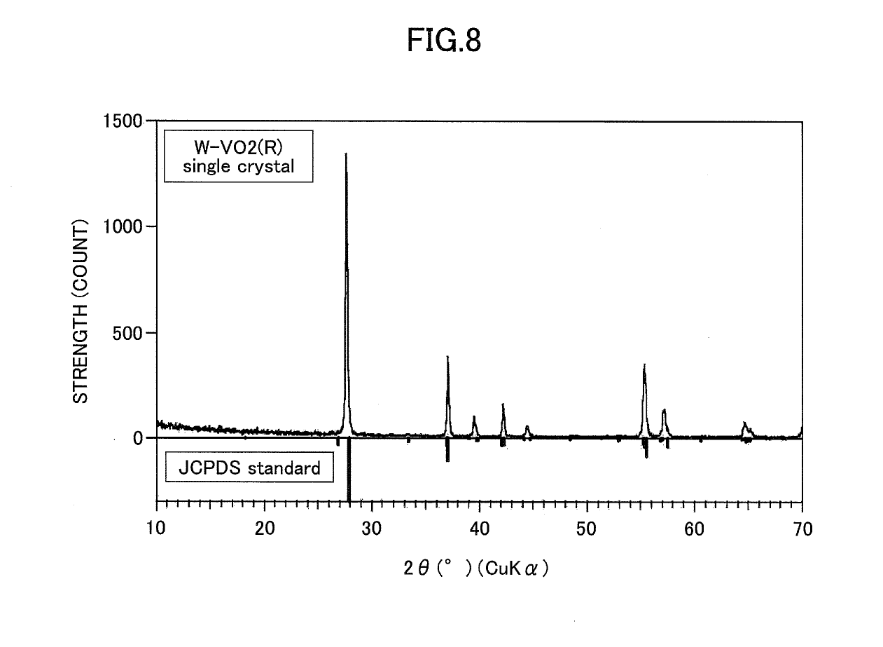

FIG. 8 is a graph showing powder X-ray diffraction (XRD) measurements of the particles of example 3 together with a standard diffraction pattern of vanadium dioxide (VO₂) crystals of the R phase (JCPDS82-0661) (the lower part of FIG. 8). As shown in FIG. 8, all diffraction peaks of the particles of example 3 also match the standard peaks of vanadium dioxide (VO₂) crystals of the R phase. This indicates that the particles are composed of R-phase crystals. Also as shown in FIG. 8, the diffraction peaks are sharp and their half widths are narrow. This indicates that although the particles are fine crystals, they have very good crystallinity.

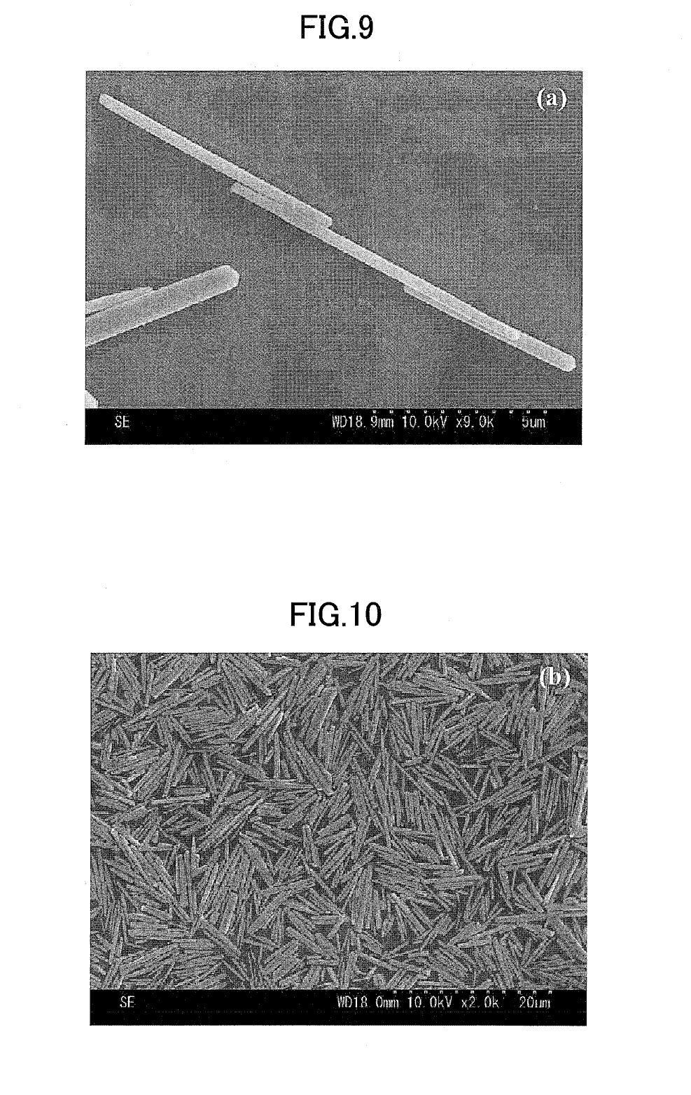

FIG. 9 is a SEM photograph of rod-shaped single crystals of the particles of example 3. The average length of the short axes of the rod-shaped crystals was less than or equal to about 500 nm, and the lengths of the long axes of the rod-shaped crystals were ten or more times greater than the average length of the short axes (i.e., aspect ratio>10). As shown in FIG. 9, the rod-shaped crystals have a typical shape and habit of single crystals. Further, TEM observation of the particles showed that the rod-shaped crystals were single crystals.

FIG. 10 is a SEM photograph of a surface of the film sample. As in FIG. 10, rod-shaped crystals of a substantially uniform size and shape were arranged on the surface of the film sample with their long axes oriented parallel to the surface of the film sample.

According to the transmittance change of the particles at a wavelength of 2000 nm, the transition temperature of the particles was about 45° C. Thus, addition of 1.5% of tungsten (W) with respect to vanadium (V) resulted in the decrease of about 24° C. in the transition temperature.

### Comparative Example 1

Commercially-available vanadium dioxide (VO₂) powder (purity of 99.9%, 180 μm mesh, Kojundo Chemical Laboratory Co., Ltd.) was applied uniformly to a surface of a commercially-available highly-transparent resin adhesive tape and the adhesive tape was affixed to a transparent resin film to obtain a film sample for evaluation. Also, an adhesive tape prepared in the same manner was affixed to a glass substrate to obtain a glass substrate sample (length 25 mm×width 25 mm×thickness 1 mm) for evaluation.

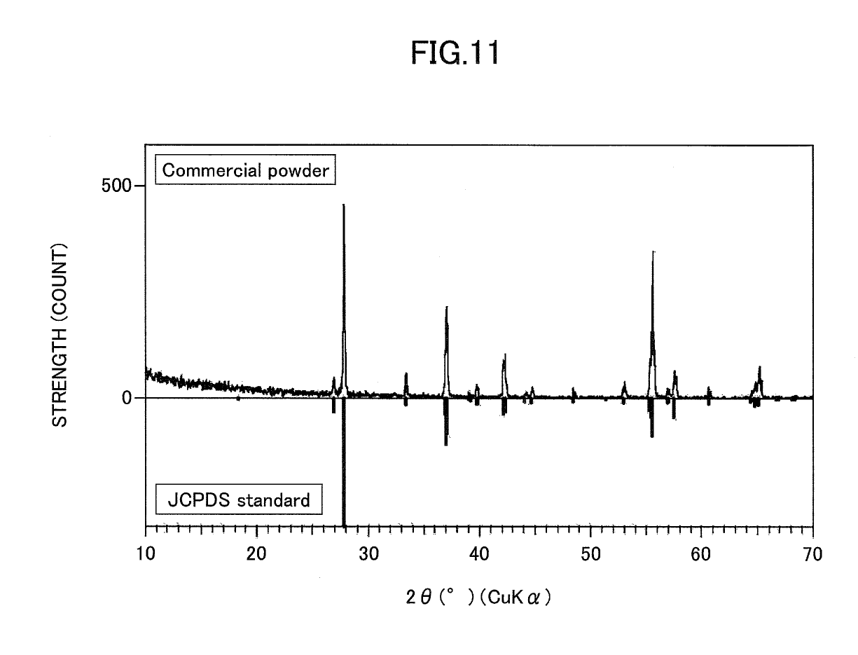

FIG. 11 is a graph showing an X-ray diffraction (XRD) pattern of the powder of comparative example 1. As a matter of course, diffraction peaks of the powder of comparative example 1 match the standard peaks of vanadium dioxide (VO₂) crystals of the R phase indicated in the lower part of FIG. 11.

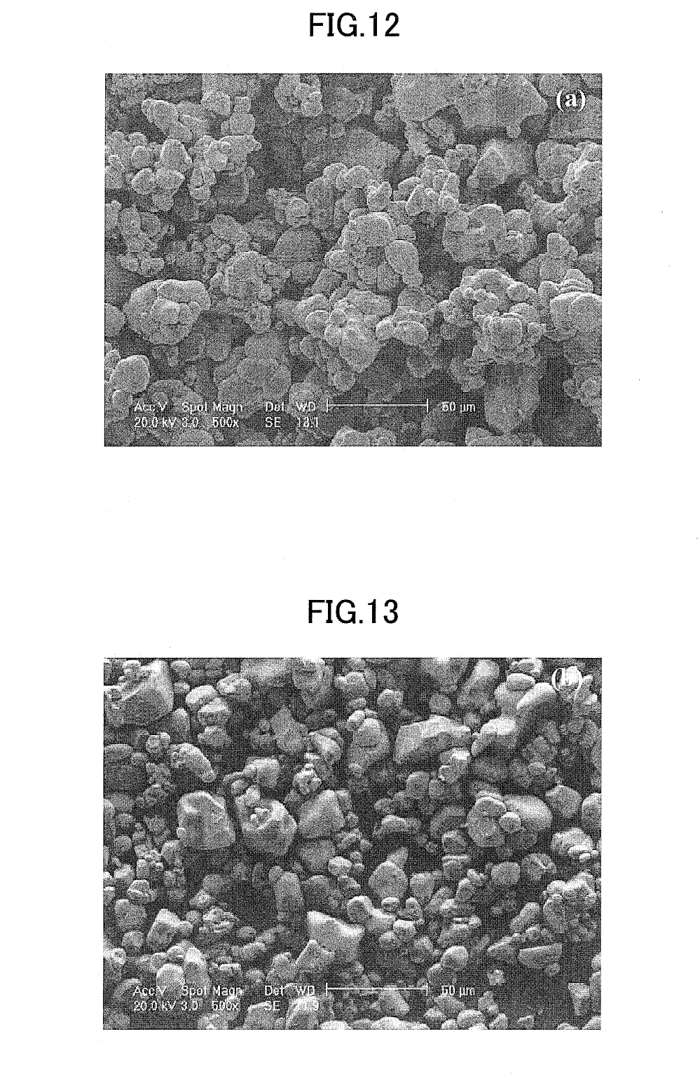

FIG. 12 is a SEM photograph of the commercially-available vanadium dioxide (VO₂) powder. FIG. 13 is a SEM photograph of the film sample of comparative example 1. As shown in FIGS. 12 and 13, the size of particles of the commercially-available vanadium dioxide (VO₂) powder is uneven and large, and the maximum size of the particles is in a micron range.

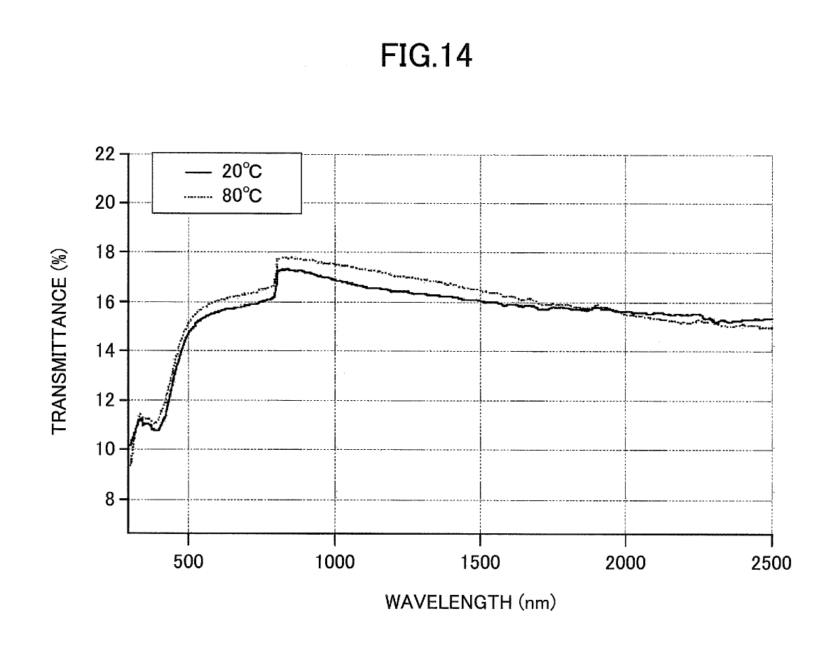

FIG. 14 is a graph showing the thermochromic property of the glass substrate sample of comparative example 1. As shown in FIG. 14, due to the large size and unevenness of the particles, the vanadium dioxide (VO₂) powder of comparative example 1 does not have a good thermochromic property.

### Comparative Example 2

Particles were prepared in substantially the same manner as in example 1, except that the hydrothermal reaction process was performed at 220° C. for 44 hours. Other conditions were the same as those in example 1.

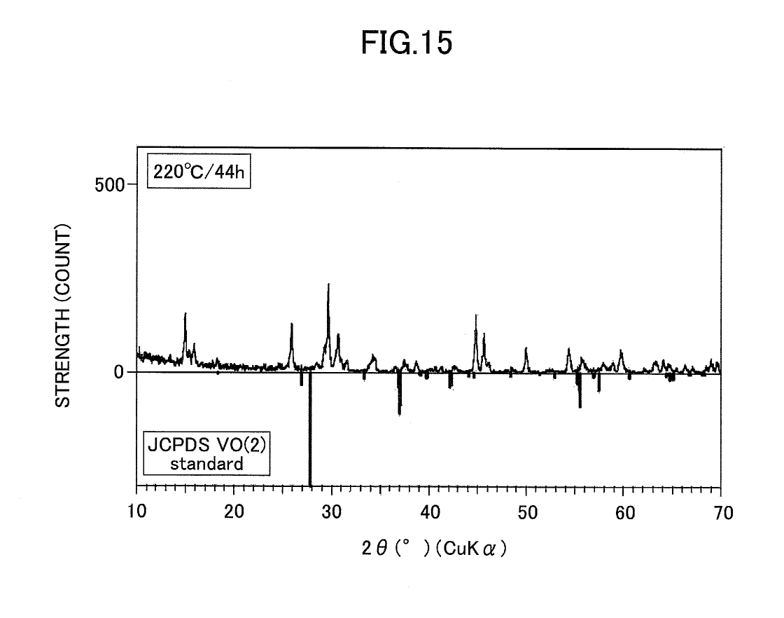

FIG. 15 is a graph showing an XRD pattern of the particles of comparative example 2. As shown by FIG. 15, the particles of comparative example 2 are not vanadium dioxide (VO₂) particles of the R phase, but are vanadium dioxide (VO₂) particles of the B phase. Also, the particles of comparative example 2 did not exhibit a substantial thermochromic property.

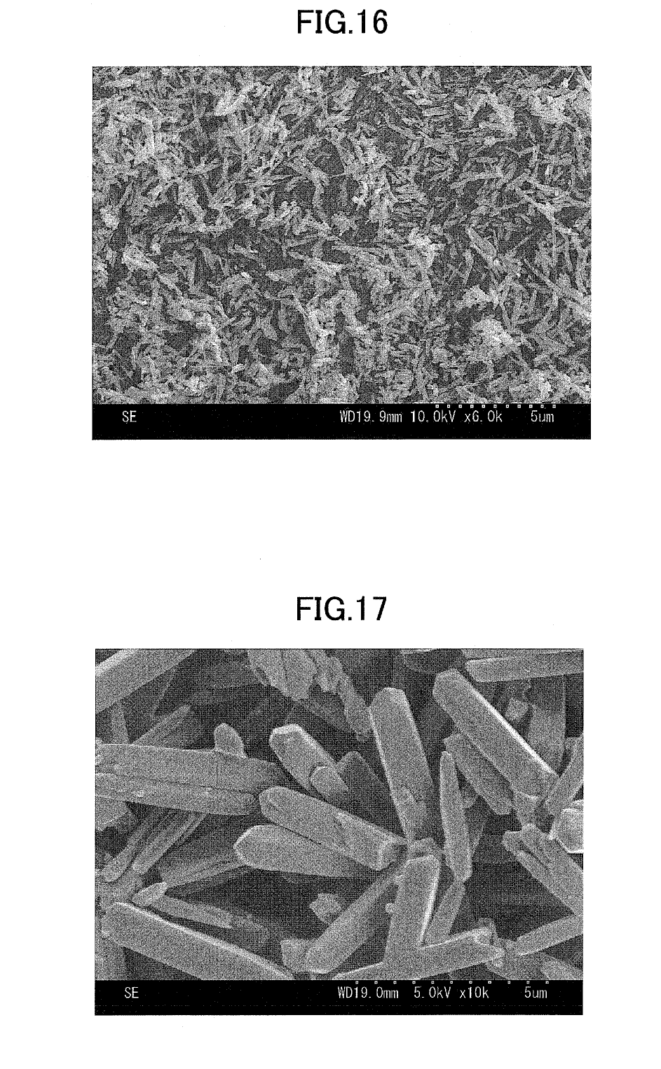

FIG. 16 is a SEM photograph of the particles of comparative example 2. As shown in FIG. 16, uniform rod-shaped crystals were not formed with the method of comparative example 2. Also, vanadium dioxide (VO₂) single crystals of the R phase were not observed with TEM.

### Example 4

Vanadium pentoxide (V₂O₅, Wako Special Grade), oxalic acid dihydrate ((COOH)₂-2H₂O, Wako Special Grade), and 200 ml of pure water were mixed and agitated at a molar ratio of 1:2:300 at the ambient temperature to prepare an aqueous solution. The pH value of the aqueous solution was adjusted to 0.7 using sulfuric acid.

Then, 0.242 g of ammonium tungstate para pentahydrate ((NH₄)10W₁₂O₄₁-5H₂O, Wako Pure Chemical Industries, Ltd.) was added to 200 ml of the aqueous solution.

Next, 10 ml of the aqueous solution was placed in a commercially-available hydrothermal reaction autoclave (HU-25 of Sanai Kagaku Corporation, HU-25 includes a body made of SUS and an inner cylinder made of Teflon (registered trademark) and having a volume of ml), and a hydrothermal reaction process was performed for 8 hours at 270° C.

Next, precipitated products in the resulting aqueous solution were extracted by filtration and washed using water and ethanol. Then, the precipitated products were dried at 60° C. for 10 hours.

Obtained particles were evaluated in substantially the same manner as in example 1.

FIG. 17 is a SEM photograph of the particles of example 4. As shown in FIG. 17, the particles are composed of rod-shaped crystals. The average length of the short axes of the rod-shaped crystals was between about 500 nm and about 1000 nm. The lengths of the long axes of the rod-shaped crystals were about 4 to 5.5 times greater than the average length of the short axes, i.e., the aspect ratio of the rod-shaped crystals was about 4 to 5.5. Also, TEM observation of the particles showed that the rod-shaped crystals were single crystals.

### Example 5

Vanadium pentoxide (V₂O₅, Wako Special Grade), oxalic acid dihydrate ((COOH)₂-2H₂O, Wako Special Grade), and 200 ml of pure water were mixed and agitated at a molar ratio of 1:2:300 at the ambient temperature to prepare an aqueous solution. The pH value of the aqueous solution was adjusted to 0.7 using sulfuric acid.

Next, 10 ml of the aqueous solution was placed in a commercially-available hydrothermal reaction autoclave (HU-25 of Sanai Kagaku Corporation, HU-25 includes a body made of SUS and an inner cylinder made of Teflon (registered trademark) and having a volume of 25 ml), and a hydrothermal reaction process was performed for 44 hours at 180° C.

Next, precipitated products in the resulting aqueous solution were extracted by filtration and washed using water and ethanol. Then, the precipitated products were dried at 60° C. for 10 hours.

Further, 0.30 g of the dried products were placed again in the hydrothermal reaction autoclave together with 10 ml of pure water, and a hydrothermal reaction process was performed for 6 hours at 270° C.

Obtained particles were evaluated in substantially the same manner as in example 1.

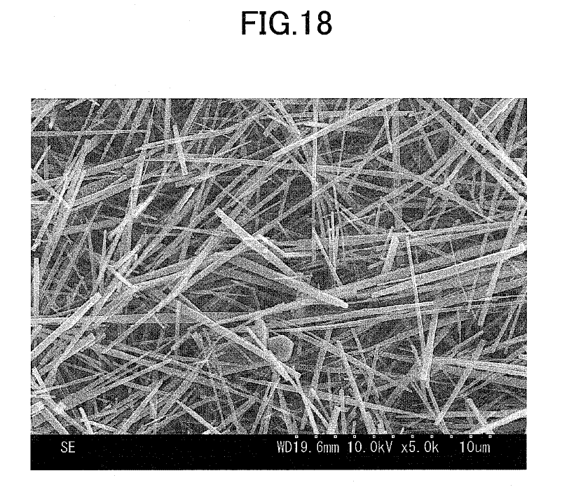

FIG. 18 is a SEM photograph of the particles of example 5. As shown in FIG. 18, the particles are composed of rod-shaped crystals. The aspect ratio of the rod-shaped crystals was several tens or greater.

### Example 6

Vanadium dioxide (VO₂) particles with surfaces modified by silane coupling were prepared in substantially the same manner as in example 1.

The silane-coupled particles were added to 2.5 ml of thinner (Aquamica (registered trademark) thinner 01, AZ Electronic Materials Corp) and milled in an agate mortar for 10 minutes. Then, 2.5 ml of a coating liquid (Aquamica (registered trademark) NAX120-20, AZ Electronic Materials Corp) including dibutyl ether as a solvent and perhydropolysilazane (Clariant Corporation) as a primary component was added and mixed by an automatic mortar for about 5 minutes to prepare a dispersion liquid (coating material). The density of the particles in the coating material was from about 0.5 wt % to about 5.0 wt %.

The obtained coating material was dripped onto an APS-coated soda-lime ground edge glass (Matsunami Glass Ind., Ltd.) with a length of 76 mm and a width of 76 mm. Then, the dripped coating material was uniformly spread over the glass using a select roller with a width of about 60 mm (DSP-10 of MATSUO SANGYO CO., LTD.). The glass was held in the ambient temperature for 24 hours to cure the coating material. As a result, a glass sample coated with the coating material was obtained.

The transmission spectrum of the glass sample was measured with a heatable spectrophotometer (V-570 of JASCO Corporation, 190-2500 nm). The measurement was performed at 20° C. and 80° C.

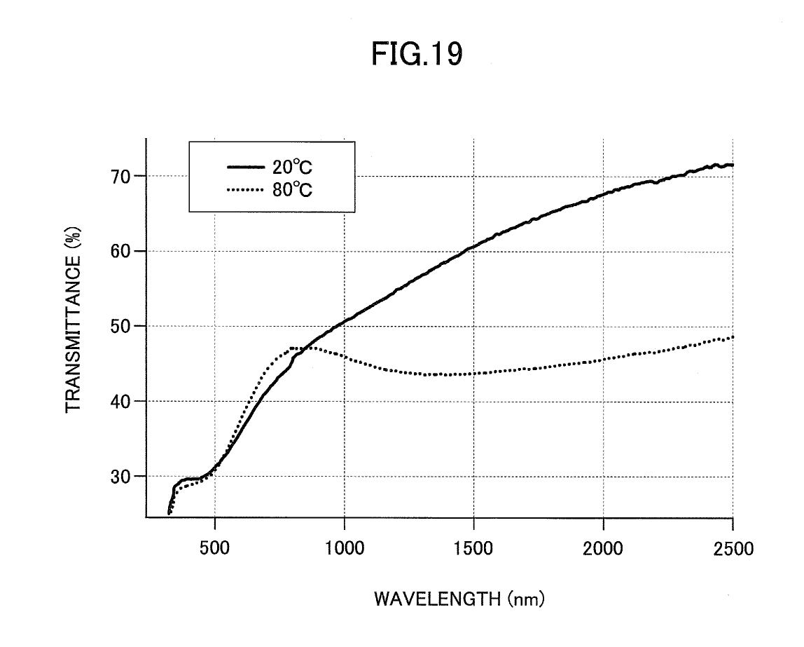

FIG. 19 is a graph showing the thermochromic property of the glass sample. When the temperature was increased from 20° C. to 80° C., the transmittance of the glass sample greatly changed. Thus, the glass sample coated with the coating material exhibited a good thermochromic property.

### Example 7

Vanadium dioxide (VO₂) particles with surfaces modified by silane coupling were prepared in substantially the same manner as in example 1.

Next, 0.5 g of the particles were added to ethanol (99.5%, Wako Pure Chemical Industries, Ltd., First Grade) and milled in an agate mortar for 10 minutes to prepare a mixed solution.

Ethanol was added further to the mixed solution so that the density of the particles became 5 wt %. Ultrasonic dispersion was performed on the mixed solution for 10 minutes to obtain a dispersion liquid.

The obtained dispersion liquid was dripped onto a commercially-available OHP sheet (MJOHPS1N of SEIKO EPSON CORPORATION). The dripped dispersion liquid was uniformly spread over the OHP sheet using a select roller with a width of about 60 mm (DSP-10 of MATSUO SANGYO CO., LTD.). The OHP sheet was dried at 60° C. for one hour using a drier to fix the film of the particles on the OHP sheet. Then, to prevent the particles from falling off, the OHP sheet was further coated with a quadruple dilution of the coating liquid (Aquamica (registered trademark) NAX120-20) used in example 6. As a result, a film sample was obtained.

The transmission spectrum of the film sample was measured with a heatable spectrophotometer (V-570 of JASCO Corporation, 190-2500 nm). The measurement was performed at 20° C. and 80° C. To more accurately determine the thermochromic property of the particles, the transmission spectrum of an OHP sheet not coated with the particles was also measured and used to correct the measurement results of the film sample.

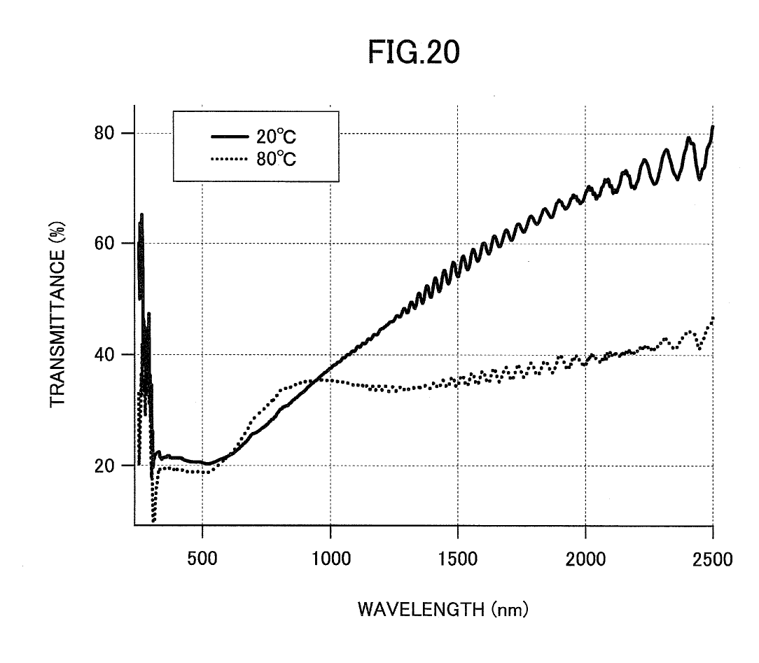

FIG. 20 shows the measurement results. As shown in FIG. 20, the film sample exhibited a good thermochromic property.

### Example 8

Silane-coupled particles were prepared in substantially the same manner as in example 1.

Next, 0.01 g of the prepared particles were put in a glass bottle (with a volume of 100 ml) containing pure water and ultrasonic dispersion was performed for about 10 minutes. The amount of pure water was adjusted so that transmitted light takes on a purple-orange color in visual observation. As a result, a translucent particle-dispersed ink sample was obtained.

The ink sample was placed in a quartz cell (with two translucent sides and dimensions of 45 mm×12.5 mm×10 mm) with a plug, and transmission spectrum of the ink sample was measured with a heatable spectrophotometer (V-570 of JASCO Corporation, 190-2500 nm). The measurement was performed at 20° C. and 80° C. To more accurately determine the thermochromic property of the particles, the transmission spectrum of pure water not including the particles was also measured and used to correct the measurement results of the ink sample.

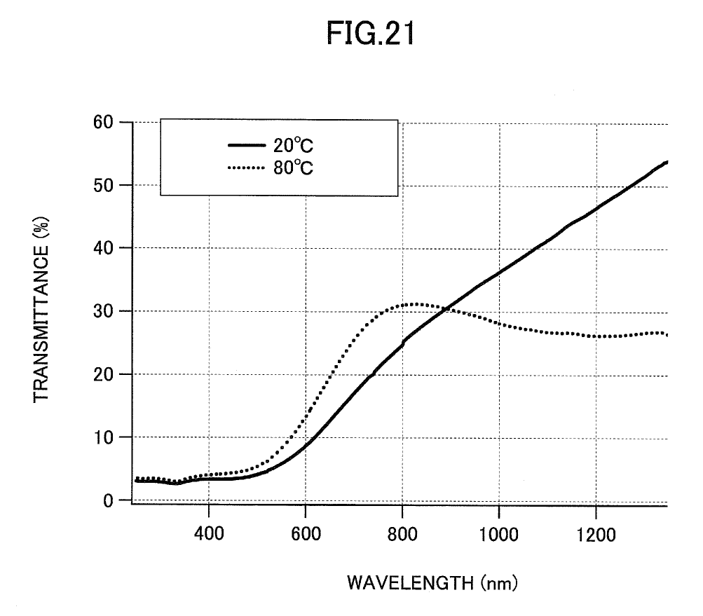

FIG. 21 shows the measurement results. As shown in FIG. 21, the ink sample exhibited a good thermochromic property.

The present invention may be applied, for example, to a multifunctional coating material having a thermochromic property, an object coated with the coating material, a resin film, ink, and a printed matter printed with the ink. The present invention may also be applied to windowpanes of vehicles and buildings, tent materials, and greenhouse films for agriculture, for example, to control the amount of incoming infrared radiation and to prevent overheating.

The present application claims priority from Japanese Patent Application No. 2009-027727 filed on Feb. 9, 2009, the entire contents of which are hereby incorporated herein by reference.

1. Particles having a thermochromic property, comprising:
rod-shaped single crystals including vanadium dioxide (VO₂), wherein
an aspect ratio of a long axis to a short axis of the rod-shaped single crystals is greater than 3 and less than or equal to 100; and
an average length of the short axes of the rod-shaped single crystals is less than or equal to 500 nm.

2. The particles as claimed in claim 1, wherein the rod-shaped single crystals further include at least one element selected from the group consisting of tungsten (W), molybdenum (Mo), niobium (Nb), tantalum (Ta), and fluorine (F).

3. The particles as claimed in claim 1, wherein the rod-shaped single crystals are two-dimensionally or three-dimensionally combined to form agglomerates.

4. Thermochromic fines obtained by grinding the particles of claim 1.

5. A method of producing particles having a thermochromic property, the method comprising:
performing a hydrothermal reaction process at a temperature of 250 degrees or higher on a solution that includes a substance A including vanadium (V), a substance B having oxidizing or reducing ability, and water, and thereby forming particles including rod-shaped single crystals that include vanadium dioxide, wherein
an aspect ratio of a long axis to a short axis of the rod-shaped single crystals is greater than 3 and less than or equal to 100; and
an average length of the short axes of the rod-shaped single crystals is less than or equal to 500 nm.

6. The method as claimed in claim 5, wherein the substance A including vanadium (V) includes at least one member selected from the group consisting of divanadium pentoxide (V₂O₅), vanadyl oxalate (VOC₂O₄), and vanadyl oxalate hydrate (VOC₂O₄-nH₂O).

7. The method as claimed in claim 5, wherein the substance B having oxidizing or reducing ability includes at least one member selected from the group consisting of oxalic acid ((COOH)₂), oxalic acid hydrate ((COOH)₂-nH₂O), and hydrogen peroxide (H₂O₂).

8. The method as claimed in claim 5, further comprising:
adding an acidic or basic substance C to the solution.

9. The method as claimed in claim 8, wherein the acidic or basic substance C includes at least one member selected from the group consisting of hydrochloric acid, nitric acid, phosphoric acid, sulfuric acid, and ammonium hydroxide.

10. The method as claimed in claim 5, wherein the hydrothermal reaction process is performed for a period of time that is less than five days.

11. The method as claimed in claim 5, further comprising:
adding a substance including at least one element selected from the group consisting of tungsten (W), molybdenum (Mo), niobium (Nb), tantalum (Ta), and fluorine (F) to the solution.

12. A coating material including the particles of claim 1.

13. A film including the particles of claim 1.

14. An ink including the particles of claim 1.
